(19) United States
(12) Patent Application Publication
(10) Pub. No.: US 2025/0344078 A1
(43) Pub. Date: Nov. 6, 2025

(54) FEATURE DEPLOYMENT IN MOBILE NETWORK WITHOUT BASE STATION DEPENDENCY

(71) Applicant: Verizon Patent and Licensing Inc., Basking Ridge, NJ (US)

(72) Inventors: Lixia Yan, Basking Ridge, NJ (US); William W. Wong, Madison, NJ (US); Michael Chen, Pittstown, NJ (US); Ce Xu, Campbell, CA (US)

(21) Appl. No.: 18/653,006

(22) Filed: May 2, 2024

(51) Int. Cl. H04W 24/02; H04W 60/04; H04W 76/10

(52) U.S. Cl. CPC H04W 24/02; H04W 60/04; H04W 76/10

(57) ABSTRACT

A base station of a mobile network receives a message from a User Equipment device (UE) that is related to providing mobile network service to the UE and identifies a local software and/or hardware configuration of the base station, including identifying installation of a set of possible new or upgraded features of the base station. The base station generates a data identifier that identifies each installed and active one of the set of possible new or upgraded features of the base station, and inserts the data identifier into an information element (IE) of the message. The base station sends the message to a node of the mobile network.

### BACKGROUND

Next Generation mobile networks, such as Fifth Generation New Radio (5G NR) mobile networks, may operate in various frequency ranges, including higher frequency ranges (e.g., in the gigahertz (GHz) frequency band), and may have a broad bandwidth (e.g., near 500-1,000 megahertz (MHz)). The bandwidth of Next Generation mobile networks supports higher speed downloads and uploads. The 5G mobile telecommunications standard supports more reliable, massive machine communications (e.g., machine-to-machine (M2M), Internet of Things (IoT)). Next Generation mobile networks, such as those implementing the 5G mobile telecommunications standard, are expected to enable a higher utilization capacity than current wireless networks, permitting a greater density of wireless users. Next Generation mobile networks are designed to increase data transfer rates, increase spectral efficiency, improve coverage, improve capacity, and reduce latency.

### BRIEF DESCRIPTION OF THE DRAWINGS

FIG. 1 depicts an example network environment in which nodes of a mobile network may be selectively upgraded with new software and/or new hardware features;

FIG. 2 depicts an example of deployment of a 5G network, and installation of new features at some network functions (NFs) of the 5G core network;

FIGS. 3A and 3B illustrate an initial technique for upgrading NFs and base stations in a mobile network with new software and/or hardware features;

FIG. 4 illustrates a technique for deploying new or upgraded features in the core network without having to deploy the new/upgraded features at each and every base station before activation of the new features at NFs in the core network;

FIG. 5 depicts a bit string that includes bits that identify which new or upgraded features have been installed at, are supported by, and are currently activated at, a base station in the mobile network;

FIG. 6A illustrates an example of the use of a bit string in a User Equipment device (UE) registration process involving NFs of the core network;

FIG. 6B illustrates an example of the use of a bit string in a UE session establishment process involving NFs of the core network;

FIG. 7 is a diagram that depicts example components of a network device, as referred to herein;

FIG. 8 is a flow diagram of an example process for a base station to notify one or more NFs of the mobile network of new or upgraded features currently installed and activated at the base station for use by the NFs during UE-related procedures;

FIG. 9 illustrates an example messaging diagram associated with a UE registering with the mobile network in circumstances where a UE Aggregate Maximum Bit Rate (UE-AMBR) feature has been installed a NF in the core network, but not installed and activated at a base station serving the registering UE; and

FIG. 10 illustrates an example messaging diagram associated with a UE registering with the mobile network in circumstances where the UE-AMBR feature has been installed at a NF in the core network and installed and activated at a base station serving the registering UE.

### DETAILED DESCRIPTION OF EXAMPLE EMBODIMENTS

The following detailed description refers to the accompanying drawings. The same reference numbers in different drawings may identify the same or similar elements. The following detailed description does not limit the invention.

Mobile networks, such as, for example, Next Generation mobile networks, typically include numerous Network Functions (NFs) that perform functions necessary to operate the mobile network and provide wireless service. Such NFs typically involve Virtual Network Functions (VNFs), Cloud-Native Network Functions (CNFs), and/or Physical Network Functions (PNFs). VNFs include network functions that have been moved out of dedicated hardware devices into software that runs on commodity hardware. VNFs may be executed as one or more Virtual Machines (VMs) on top of the hardware networking infrastructure. CNFs include software implementations of functions that typically execute in a containerized environment. PNFs include physical network nodes, which have not undergone virtualization, that implement one or more NFs (e.g., hardware NFs).

NFs, such as VNFs, CNFs, and PNFs, are often upgraded, or replaced in their entirety, to incorporate new functions or operations into the NF software and/or hardware functionality. For example, NFs of the mobile network may be upgraded to support new features that involve interaction with other nodes of the mobile network. When a new feature is installed on a core NF of a 5G mobile network, such as a Policy Control Function (PCF) or Session Management Function (SMF), activation of the new feature at the core NF impacts all of the Next Generation nodeBs (gNBs) or evolved nodeBs (eNBs) that communicate with that core NF. If any of the gNBs/eNBs that communicate with the upgraded core NF are not configured to support the new feature, the gNBs/eNBs may behave unpredictably, and possibly erroneously, negatively impacting service to UEs that are serviced by the particular gNBs/eNBs.

When installing a new feature that impacts core NFs and gNBs/eNBs of the mobile network, it is typically not possible to install and activate a new feature on a single gNB/eNB and a single core NF to perform a field operations assessment (FOA) involving only that gNB/eNB and core NF, without negatively impacting other gNBs/eNBs within a same coverage area serviced by the core NF. Therefore, during installation of a new feature within core NFs of a mobile network using existing processes, the operations team has to install and activate the new feature on all of the gNBs/eNBs within the core NF's coverage area first, and then install and activate the corresponding new feature on the core NF before performing FOAs to validate the successful interaction between the upgraded gNBs/eNBs and the upgraded core NF. This installation and FOA process, involving numerous gNBs/eNBs and the serving core NF, is time consuming and difficult to coordinate across the various gNBs/eNBs and NFs of the mobile network that are impacted by the upgraded feature. It would, therefore, be desirable to have the capability to install and activate a new software and/or hardware feature on core NFs independently of installing and activating the same new feature on the gNBs/eNBs served by those core NFs, without causing the unpredictable and possibly erroneous behavior of non-upgraded gNBs/eNBs.

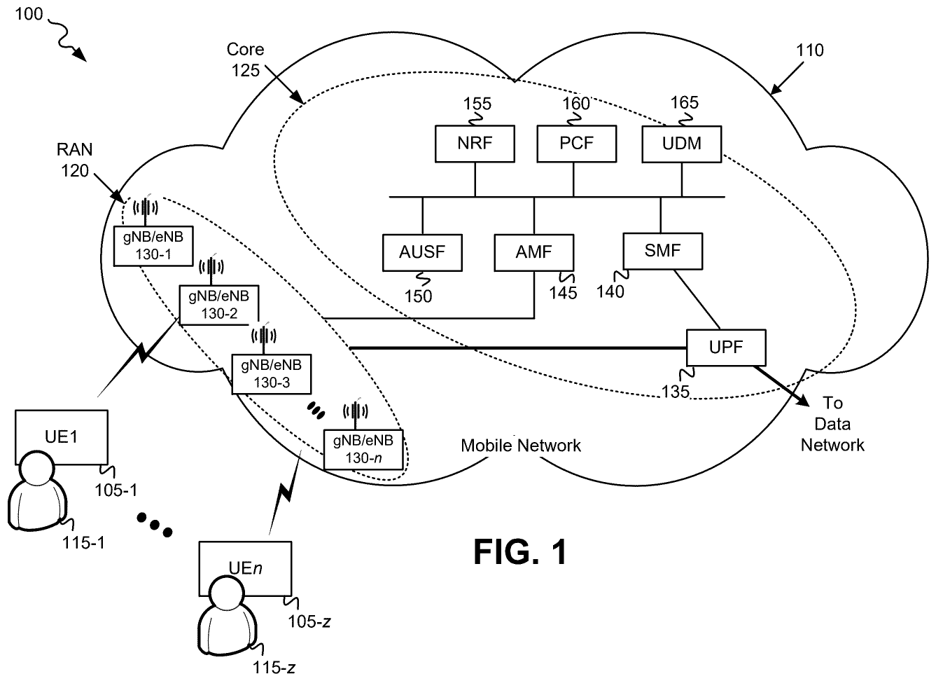

FIG. 1 depicts an example network environment 100 in which nodes (e.g., NFs, base stations) of a mobile network may be selectively upgraded with new software and/or hardware features, as described further herein. As shown, network environment 100 includes User Equipment devices (UEs) 105-1 through 105-z and a mobile network 110. UEs 105-1 through 105-z (referred to herein as “UE 105” or “UEs 105”) may each include any type of electronic device having a wireless communication capability. Though only two UEs 105 are shown, network environment 100 may include numerous UEs (e.g., z>>2). UE 105 may include, for example, a laptop, palmtop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (also referred to herein as a “subscriber”) may carry, use, administer, and/or operate each UE 105. For example, as shown, a first user 115-1 may operate UE 105-1 and a second user 115-z may operate UE 105-z.

Mobile network 110 (also referred to herein as “wireless network 110” or “network 110”) may include any type of a Public Land Mobile Network (PLMN). In some implementations, mobile network 110 may include any type of a Next Generation mobile network that may include evolved network components (e.g., future generation components) relative to a Long-Term Evolution (LTE) network, such as a Fourth Generation (4G) or 4.5G mobile network. For example, mobile network 110 may include a 5G mobile network. Mobile network 110 may alternatively include another type of Next Generation network, other than the 5G network shown in FIG. 1, such as, for example, a Sixth Generation (6G) mobile network. Furthermore, though mobile network 110 is depicted in FIG. 1 as a 5G network having 5G network components/functions, mobile network 110 may additionally or alternatively include a 4G or 4.5G network with corresponding network components/functions, or a hybrid Next Generation/4G network that includes certain components of both a Next Generation network (e.g., a 5G network) and a 4G network.

As shown, mobile network 110 may include sub-networks, such as a Radio Access Network (RAN) 120 and a mobile core network 125. RAN 120 may include various types of radio access equipment that enable Radio Frequency (RF) communication with UEs 105. The radio access equipment of RAN 120 may include, for example, multiple gNBs or eNBs (gNBs/eNBs) 130-1 through 130-n (also referred to herein as “base stations”). Each gNB 130 may include a Centralized Unit (CU) (not shown), one or more Distributed Units (DUs) (not shown), and one or more Radio Units (RUs)(not shown).

Each CU of a gNB 130 includes a network device that operates as a digital function unit that transmits digital baseband signals to the DUs of the gNB 130, and receives digital baseband signals from the DUs of the gNB 130. Each CU of a gNB 130 may interconnect with the DUs of the gNB 130 via fronthaul links or a fronthaul network. The DUs perform centralized processing and coordination of multiple RUs of the gNB 130, handle tasks such as scheduling and overall control of the radio resources, and interface with the core NFs to establish and manage connections with UEs 105 and to facilitate communication between different cells. The RUs of a gNB 130 may include network devices, that may be located at certain geographic positions within mobile network 110, and which operate as radio function units that transmit and receive RF signals to/from UEs 105. Each of the RUs may include at least one antenna array, transceiver circuitry, and other hardware and software components for enabling the RUs to receive data via wireless RF signals from UEs 105, and to transmit wireless RF signals to UEs 105. Each RU of a gNB 130 further connects to a respective DU of the gNB 130 that may serve as a coordinator for multiple RUs. In other implementations, one or more of the gNBs 130 of RAN 120 may instead be an evolved NodeB (eNB), which may also be referred to herein as a “base station.” RAN 120 may additionally include other nodes, functions, and/or components not shown in FIG. 1.

Core network 125 includes devices or nodes that host and execute NFs that operate the mobile network 110 including, among other NFs, mobile network access management, session management, and policy control NFs. In the example network environment 100 of FIG. 1, core network 125 is shown as including 5G NFs, such as a User Plane Function (UPF) 135, a Session Management Function (SMF) 140, an Access and Mobility Management Function (AMF) 145, an Authentication Service Function (AUSF) 150, a Network Repository Function (NRF) 155, a Policy Control Function (PCF) 160, and a Unified Data Management (UDM) function 165. Each of UPF 135, SMF 140, AMF 145, AUSF 150, NRF 155, PCF 160, and UDM 165 may be implemented as a VNF or a CNF (e.g., at a data center(s)) or as a PNF within mobile network 110.

UPF 135 may act as a router and a gateway between mobile network 110 and an external data network (not shown), and forwards session data between the external data network and RAN 120. Though only a single UPF 135 is shown in FIG. 1, mobile network 110 may include multiple UPFs 135 at various locations in mobile network 110. SMF 140 performs session management and selects and controls UPFs 135 for data transfer. AMF 145 performs mobility management for the UEs 105.

AUSF 150 may implement authentication and security key management functions for authorizing UE access to mobile network 110 and for establishing secure connections. AUSF 150 further interacts with AMF 145 to manage subscriber mobility and handover procedures, supports session management, and interacts with UDM 165 to manage subscriber data and profiles.

NRF 155 operates as a centralized repository of information regarding NFs in mobile network 110. NRF 155 enables NFs (e.g., UPF 135, SMF 140, AMF 145, PCF 160, UDM 165) to register and discover each other via an Application Programming interface (API). NRF 155 maintains an updated repository of information about the NFs available in mobile network 110, along with information about the services provided by each of the NFs. NRF 155 further enables the NFs to obtain updated status information of other NFs in mobile network 110. NRF 155 may, for example, maintain profiles of available NF instances and their supported services, allow NF instances to discover other NF instances in mobile network 110, and allow NF instances to track the status of other NF instances.

PCF 160 may provide policy rules for control plane functions (e.g., for network slicing, roaming, and/or mobility management) and may access user subscription information for policy decisions. UDM 165 manages data for user access authorization, user registration, and data network profiles. UDM 165 may include, or operate in conjunction with, a User Data Repository (UDR—not shown) which stores user data, such as customer/subscriber profile information, customer/subscriber authentication information, user-subscribed network slice information, and encryption keys.

The configuration of network components of the example mobile network 110 of FIG. 1 is for illustrative purposes. Other configurations may be implemented. Therefore, mobile network 110 may include additional, fewer, and/or different components that may be configured in a different arrangement than that depicted in FIG. 1. For example, core network 125 may include other NFs not shown in FIG. 1. Furthermore, mobile network 110 may connect to one or more other types of networks, such as, for example, a data network. The data network may include one or more local area networks (LANs), wide area networks (WANs), metropolitan area networks (MANs), Public Switched Telephone Networks (PSTNs), and/or the Internet.

Additionally, though only a single instance of each of the NFs (e.g., UPF 135, SMF 140, AMF 145, AUSF 150, NRF 155, PCF 160, UDM 165) is shown in FIG. 1, mobile network 110 may include multiple instances of each of the NFs. When implemented as VNFs or CNFs, each of the NFs described above may be installed in, and be executed by, a network device residing in mobile network 110, or in another network (e.g., in an edge or a far edge network, not shown). A single network device may host and execute one or more of the NFs described above, and mobile network 110 may include at least one network device, or may have multiple (e.g., numerous) network devices that each host and execute one or more of the NFs described above.

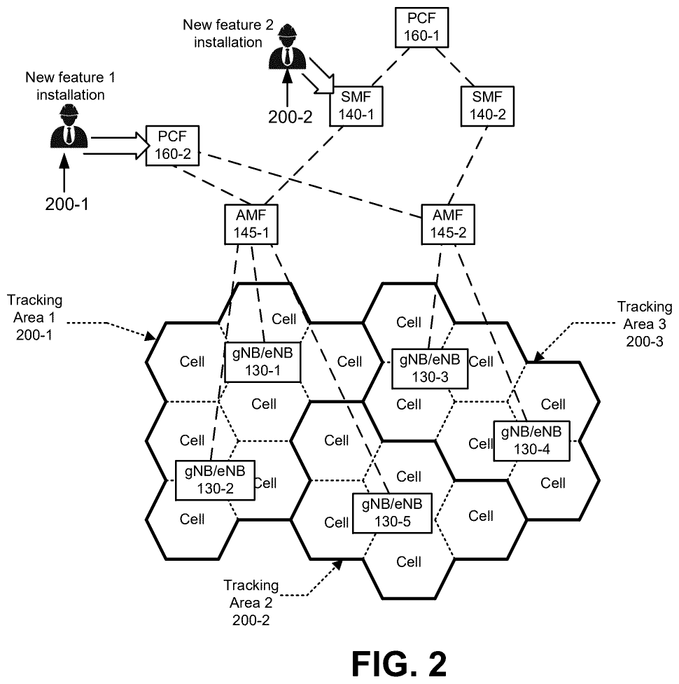

FIG. 2 depicts an example of deployment of a 5G network, and installation of new features at some NFs (e.g., PCFs and SMFs) of the 5G core network. As shown, AMF 145-1 serves gNB/eNB 130-1 and gNB/eNB 130-2 within tracking area 200-1 and gNB/eNB 130-5 within tracking area 200-2. A tracking area 200 within the 5G network includes a set of cells, and their corresponding network devices and equipment, that are typically geographically contiguous with one another. AMF 145-2 further serves gNB/eNB 130-3 and 130-4 within tracking area 200-3. PCF 160-1 serves SMFs 140-1 and 140-2, and PCF 160-2 serves AMFs 145-1 and AMF 145-2. Furthermore, SMF 140-1 serves AMF 145-1 and SMF 140-2 serves 145-2. In this example, PCF 160-1 may include a Session Management control PCF (SM-PCF) and PCF 160-2 may include an Access and Mobility control PCF (AM-PCF). Since SMF 140-1 serves AMF 145-1, which in turn serves gNBs/eNBs 130-1, 130-2 and 130-5, then AMF 145-1 and SMF 140-1 receive and handle session management traffic from UEs residing in cells served by gNBs/eNBs 130-1, 130-2, and 130-5. Further, since SMF 140-2 serves AMF 145-2, which in turn serves gNBs/eNBs 130-3 and 130-4, then AMF 145-2 and SMF 140-2 receive and handle session management traffic from UEs residing in cells served by gNBs/eNBs 130-3 and 130-4. PCF 160-2 also serves AMF 145-1 and AMF 145-2, which in turn serve gNBs/eNBs 130-1 through 130-5 and, therefore, receives and handles access and mobility management traffic involving UEs residing in cells served by gNBs/eNBs 130-1 through 130-5.

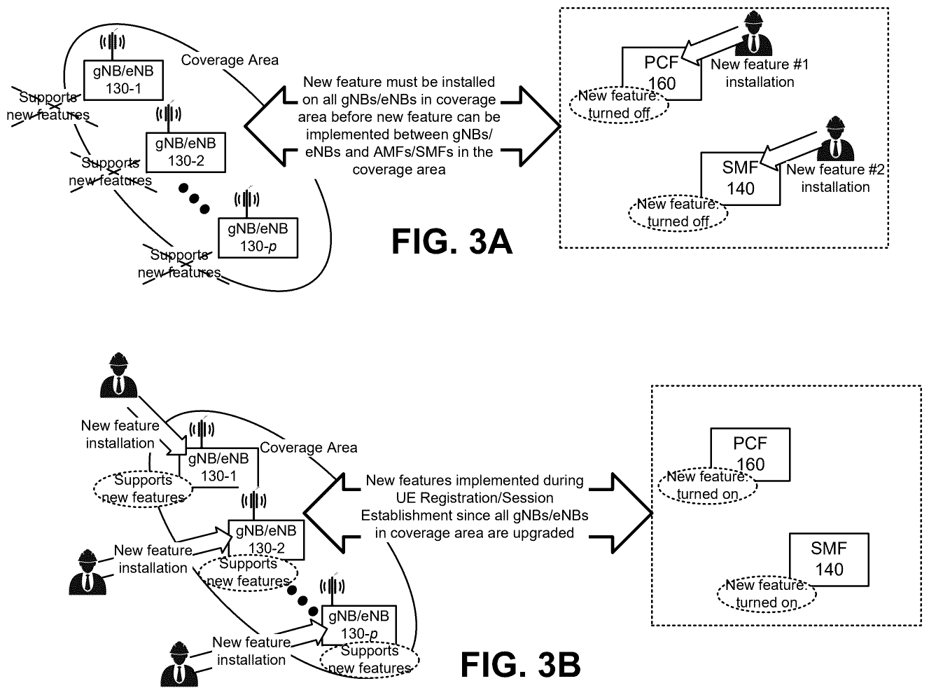

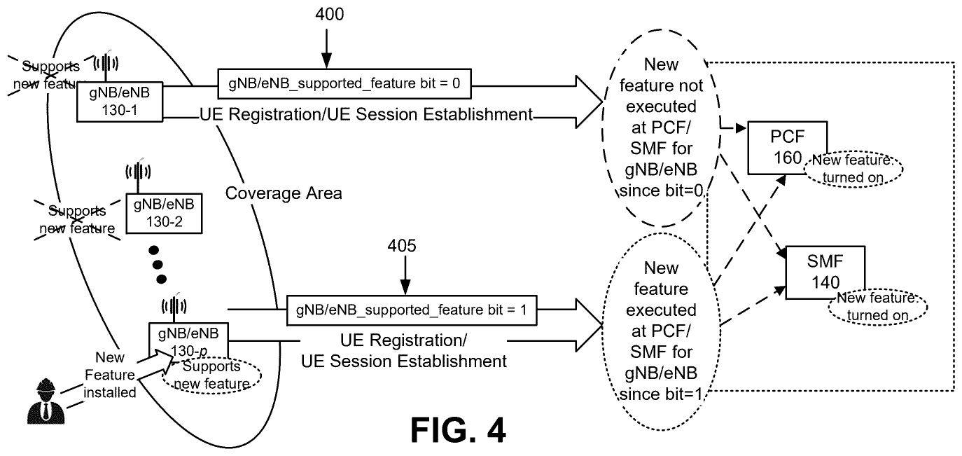

FIG. 2 further depicts examples of installation of new or upgraded software and/or hardware features (e.g., functions/operations) at PCF 160-2 and SMF 140-1. As shown, a first new/upgraded software and/or hardware feature is installed 200-1 at PCF 160-2, and a second new/upgraded software and/or hardware feature is installed 200-2 at SMF 140-1. Using an existing process, to enable compatibility and ensure successful interactions between PCF 160-2 and the AMFs 145-1 and 145-2 and gNBs/eNBs 130-1 through 130-5, corresponding first new/upgraded software and/or hardware features need to be installed at AMFs 145-1 and 145-2 and gNBs/eNBs 130-1 through 130-5. Additionally, using the existing process, to enable compatibility and ensure successful interactions between SMF-1 and AMF 145-1 and gNBs/eNBs 130-1, 130-2, and 130-5, corresponding second new/upgraded software and/or hardware features need to be installed at AMF 145-1 and gNBs/eNBs 130-1, 130-2, and 130-5. Issues with installing new/upgraded software and/or hardware features within the mobile network 110, using an existing process, are described further below with respect to FIGS. 3A, 3B, and 4.

FIGS. 3A and 3B illustrate an initial technique for upgrading NFs and gNBs/eNBs in mobile network 110 with new/upgraded software and/or hardware features. As shown in FIG. 3A, a new software and/or hardware feature #1 is installed at a PCF 160 in mobile network 110, but initially kept in an inactivated (i.e., turned off) state. Further, a new software and/or hardware feature #2 is installed at a SMF 140 in mobile network 110, but also initially kept in an inactivated (i.e., turned off) state. gNBs/eNBs 130-1 through 130-p, in a particular coverage area, have not yet been installed with the new features and, therefore, do not yet support the new features already installed at PCF 160 and SMF 140. The coverage area shown in FIG. 3A may encompass all of the gNBs/eNBs that are served by PCF 160 and/or SMF 140. Using an existing process for upgrading NFs and gNBs/eNBs, as described further below in FIG. 3B, corresponding software and/or hardware upgrades must also be installed at all of the gNBs/eNBs 130-1 through 130-p in the coverage area before the new feature(s) (e.g., new feature #1 and new feature #2) can be activated at PCF 160 and SMF 140 for interactions, that implement the new features, between the gNBs/eNBs 130 and the PCF 160 and/or SMF 140 in the coverage area. If new feature #1 or new feature #2 are activated at PCF 160 or SMF 140, and corresponding feature upgrades are not made and activated at one or more of the gNBs/eNBs 130 within the coverage area, each non-upgraded gNB/eNB 130 in the coverage area may behave unpredictably and/or erroneously when interacting with the upgraded PCF 160 or SMF 140.

FIG. 3B shows completion of the technique of FIG. 3A for installing a new feature(s) that involves one or more NFs and gNBs/eNBs in the mobile network 110. After installation of the new/upgraded features at PCF 160 and SMF 140, shown in FIG. 3A, the corresponding new/upgraded software and/or hardware feature(s) are then installed and activated at each of the gNBs/eNBs 130-1 through 130-p in the coverage area such that each of the gNBs/eNBs 130-1 through 130-p support the new feature(s). Therefore, the newly installed features (e.g., features #1 and #2 of FIG. 3A) may then subsequently be implemented during UE-related processes (e.g., UE registration, UE session establishment) involving PCF 160 and/or SMF 140 since all gNBs/eNBs 130 in the coverage area have been upgraded with the corresponding feature(s).

FIG. 4 illustrates a technique, described in further detail herein, for deploying new or upgraded features at one or more NFs in the core network 125 without having to deploy the new/upgraded features at each and every gNB/eNB 130 in a particular NF coverage area before activation of the new/upgraded features at the one or more NFs. The technique described herein involves a gNB/eNB 130 maintaining knowledge of what new/upgraded features have been locally installed, and generating a “gNB/eNB supported feature” bit string that identifies which new or upgraded features have been locally installed and are currently active at a gNB/eNB 130. The bit string is exchanged by the gNB/eNB 130 with one or more NFs of the core network 125 in an information element (IE) of particular messages sent between the gNB/eNB 130 and the core network 125, such as, for example, UE registration messages used to register a UE with the core network 125 and/or session establishment messages used to establish a session between a UE and the core network 125. Other types of messages, not described herein, may also carry the IE including the “gNB/eNB supported feature” bit string for use by NFs in the core network 125.

The NFs of the core network 125 may extract the “gNB/eNB supported feature” bit string from the IE of the received messages (e.g., UE registration messages, UE session establishment messages), and determine which new/upgraded features have been installed and activated at a particular gNB/eNB 130 based on the bit values of the bit string. The NFs of the core network 125 may then, based on the determined and active new/upgraded features for a particular gNB/eNB 130, execute the corresponding new/upgraded functionality at the NFs for procedures related to UEs currently being served by the particular gNB/eNB 130. Executing the new/upgraded functionality at the core network 125 NFs may involve executing a particular action(s), or having a particular response, to a UE-related message (e.g., UE registration message, UE session establishment message) received from a particular gNB/eNB 130, based on which new/upgraded features are currently supported by the gNB/eNB 130. If, for example, the upgraded NF of the core network 125 is a PCF 145, then the PCF 145, based on the determined new/upgraded features at the gNB/eNB 130, may execute a particular UE policy response for registration requests involving UEs 105 served by the gNB/eNB 130. As another example, if the upgraded NF of the core network 125 is a SMF 140, then the SMF 140, based on the determined new/upgraded features of the gNB/eNB 130, may execute a particular session management procedure for UE sessions involving the gNB/eNB 130.

As shown in the example of FIG. 4, a new/upgraded feature has previously been installed, and activated, at PCF 160 and SMF 140. gNBs/eNBs 130-1 and 130-2, however, have not been installed with, and do not support, a new/upgraded feature, whereas the new/upgraded feature has been installed and activated at gNB/eNB 130-p. During, for example, UE registration or UE session establishment involving a UE served by gNB/eNB 130-1, gNB/eNB 130-1 sends a message to one or more NFs of the core network 125 (e.g., PCF 160 and/or SMF 140) that includes a bit string having a “gNB/eNB_new_feature_IE” bit 400 equal to zero, indicating that gNB/eNB 130-1 does not currently support the particular new/upgraded feature identified by the bit 400, or that the new/upgraded feature is not currently activated (i.e., turned on) at the gNB/eNB 130-1. Therefore, the new/upgraded feature, identified by the bit 400 within the bit string, is not executed at the core NFs (e.g., PCF, SMF) for UEs currently served by gNB/eNB 130-1 since “gNB/eNB_new_feature” bit 400 is equal to zero.

As another example, during UE registration or UE session establishment involving a UE served by gNB/eNB 130-p, gNB/eNB 130-p sends a message to one or more NFs of the core network 125 (e.g., PCF 160 and/or SMF 140) that includes a bit string having a “gNB/eNB_new_feature” bit 405 set to one, indicating that gNB/eNB 130-p currently supports the particular new/upgraded feature identified by the bit 405, and the new/upgraded feature is also currently activated. Therefore, the new/upgraded feature, identified by the bit 405 within the “gNB/eNB supported feature” bit string, is executed at the core NF (e.g., PCF, SMF) currently served by gNB/eNB 130-p since “gNB/eNB_new_feature_IE” bit 405 is set to one. Though FIG. 4 depicts PCF 160 and SMF 140 as the NFs of the core network 125 being involved in executing new/upgraded features, other NFs of mobile network 125, that are not shown in FIG. 4, may have new/upgraded features installed and activated at them, and may selectively execute those new/upgraded features for UE-related traffic from a particular gNB/eNB 130 based on the “gNB/eNB supported feature” bit string received from that gNB/eNB 130.

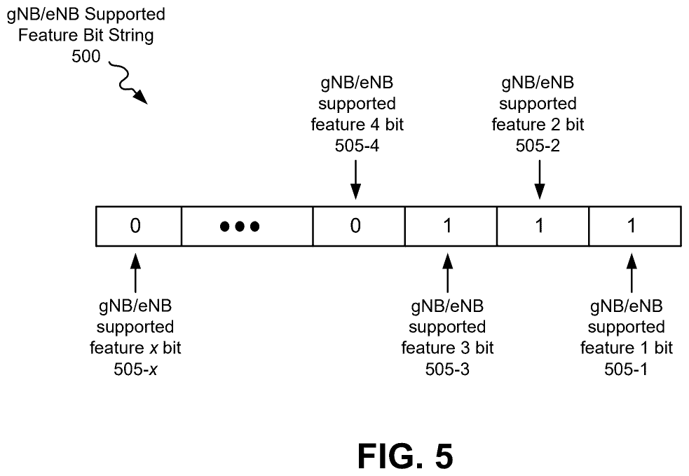

FIG. 5 depicts an example of a “gNB/eNB supported feature” bit string 500 that includes bits that identify which new or upgraded features have been installed at, are supported by, and are currently activated at, a gNB/eNB 130. The bit string 500 may include x bits (where x is greater than or equal to one), with each of the x bits corresponding to a different new or upgraded feature that can be implemented involving interactions between the gNB/eNB 130 and one or more NFs in the core network 125. When a particular new/upgraded feature is installed and activated at a gNB/eNB 130, then the corresponding bit of bit string 500 is set to one. When a particular new/upgraded feature has not yet been installed, or is currently inactivated, at a gNB/eNB 130, then the corresponding bit of bit string 500 is reset so as to equal zero. For example, referring to the bit string 500 of FIG. 5, new feature/upgrade #1, corresponding to bit 505-1, is set to one, indicating that new feature/upgrade #1 has been installed at gNB/eNB 130 and is currently activated. As another example, new feature/upgrade #3, corresponding to bit 505-3, is also set to one, indicating that new feature/upgrade #3 has been installed at gNB/eNB 130 and is currently activated. As a further example, new feature/upgrade #x, corresponding to bit 505-x, is reset (i.e., equal to zero), indicating that new feature/upgrade #x has not been installed at gNB/eNB 130 or is currently installed but inactivated.

In some implementations, new feature/upgrade #1 may be a UE Aggregate Maximum Bit Rate (UE-AMBR) feature, new feature/upgrade #2 may be a “Voice over NR Service” feature, new feature/upgrade #3 may be a UE-slice-AMBR support feature, and new feature/upgrade #4 may be a “high throughput” support feature. The UE-AMBR feature uses at least one UE-AMBR parameter, described further below, that controls a maximum aggregate data rate allowed for a UE 105 on the downlink (DL) and/or uplink (UL) to/from a gNB/eNB 130.

A “Voice over NR Service” feature enables Voice over NR Service for sessions involving the gNB/eNB 130 and the UEs 105 that are served by the gNB/eNB 130. A UE-slice-AMBR support feature uses at least one UE-slice-AMBR parameter that controls a maximum aggregate data rate allowed for a particular UE 105 within a particular network slice on the DL and/or UL to/from the gNB/eNB 130. A “high throughput” support feature enables a higher level of throughput for a particular UE 105, among other UEs 105, that is served by the gNB/eNB 130.

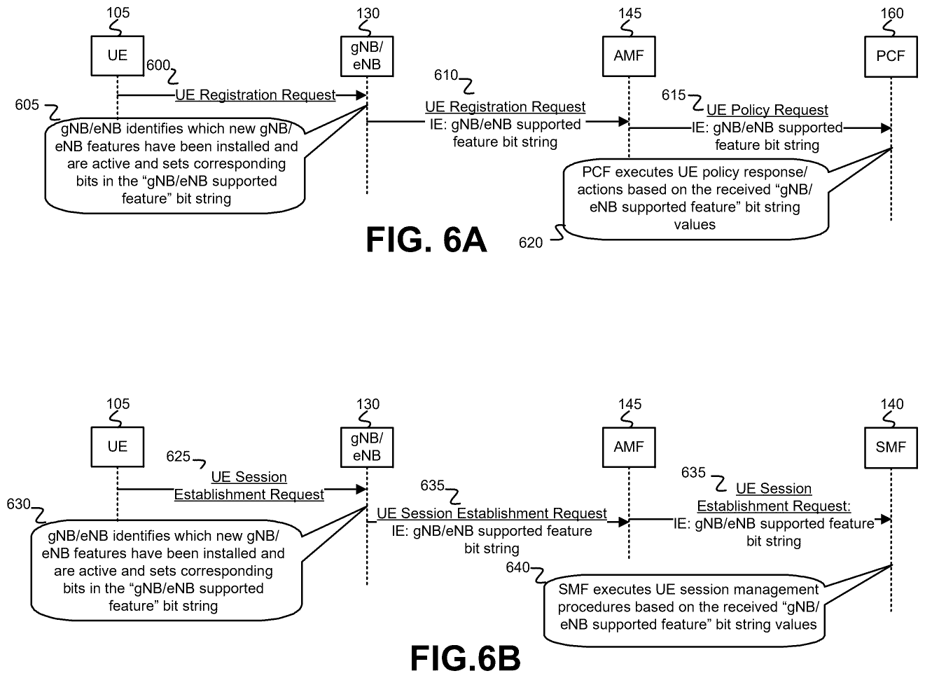

FIG. 6A illustrates an example of the use of a bit string 500 in a UE registration process involving NFs of the core network 125. The UE registration process begins with a UE 105, that is served by a gNB/eNB 130, sending a UE registration request 600 to the gNB/eNB 130. Upon receipt of the UE registration request 600, gNB/eNB 130 identifies a local software/hardware configuration of the gNB/eNB 130, including which new/upgraded software and/or hardware features have been installed at gNB/eNB 130 and are currently active, and sets corresponding bits (bit set to equal 1) in the “gNB/eNB supported feature” bit string. gNB/eNB 130 then inserts the “gNB/eNB supported feature” bit string as an IE into a UE registration request 610, and sends the request 610 to the AMF 145 that is serving the gNB/eNB 130. In response to receipt of the UE registration request 610, AMF 145 generates a UE policy request 615, inserts an IE that includes the “gNB/eNB supported feature” bit string into the request 615, and sends the request 615 to the PCF 160 that serves the AMF 145. Upon receipt of the UE policy request 615, PCF 160 subsequently executes a UE policy response or UE policy action(s) based on the received “gNB/eNB supported feature” bit string values. The UE policy response may include, for example, deriving UE-related policies based on which new/upgraded features are identified by the “gNB/eNB supported feature” bit string values as being installed and activated at the gNB/eNB 130, and returning those UE-related policies to AMF 145 that serves the gNB/eNB 130.

FIG. 6B illustrates an example of the use of a bit string 500 in a UE session establishment process involving NFs of the core network 125. The UE session establishment process begins with a UE 105, that is served by a gNB/eNB 130, sending a UE session establishment request 625 to the gNB/eNB 130. Upon receipt of the UE session establishment request 625, gNB/eNB 130 identifies a local software/hardware configuration of the gNB/eNB 130, including which new/upgraded software and/or hardware features have been installed at gNB/eNB 130 and are currently active, and sets corresponding bits (bit equal to 1) in the “gNB/eNB supported feature” bit string. gNB/eNB 130 then inserts the “gNB/eNB supported feature” bit string as an IE into a UE session establishment request 635, and sends the request 635 to the AMF 145 that is serving the gNB/eNB 130. AMF 145 forwards the UE session establishment request 635 to the SMF 140 that is serving the AMF 145. Upon receipt of the request 635, SMF 140 executes UE session management procedures based on the received “gNB/eNB supported features” bit string values. The UE session management procedures may include, if the “gNB/eNB supported features” bit string values indicate that a “Voice over NR service” feature is supported by the gNB/eNB 130, SMF 140 altering the hand-off procedures for UEs 105 moving into a cell served by the gNB/eNB 130 or for UEs 105 moving out of a cell served by the gNB/eNB 130 to a cell served by a different gNB/eNB 130.

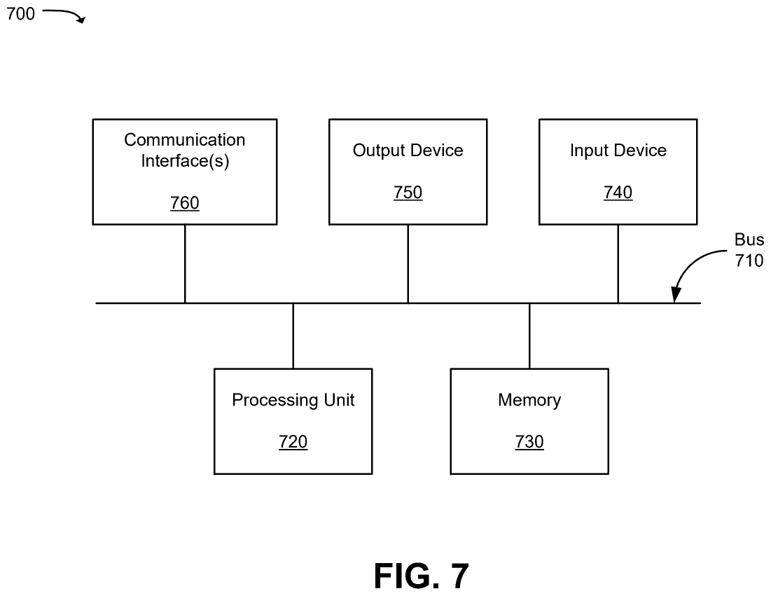

FIG. 7 is a diagram that depicts example components of a network device 700 (referred to herein as a “network device” or a “device”). UEs 105 and the RUs, DUs, and/or CUs of each gNB/eNB 130 may include components that are the same as, or similar to, those of device 700 shown in FIG. 7. Furthermore, each of the NFs in mobile network 110 (e.g., UPF 135, SMF 140 AMF 145, AUSF 150, NRF 155, PCF 160, and/or UDM 165) may be implemented by a device that includes components that are the same as, or similar to, those of network device 700. Some of the NFs of mobile network 110 may be implemented by a same device 700 within mobile network 110, while others of the functions may be implemented by one or more separate devices 700 within mobile network 110.

Device 700 may include a bus 710, a processing unit 720, a memory 730, an input device 740, an output device 750, and a communication interface 760. Bus 710 may include a path that permits communication among the components of device 700. Processing unit 720 may include one or more processors or microprocessors which may interpret and execute instructions, or processing logic. Memory 730 may include one or more memory devices for storing data and instructions. Memory 730 may include a random access memory (RAM) or another type of dynamic storage device that may store information and instructions for execution by processing unit 720, a Read Only Memory (ROM) device or another type of static storage device that may store static information and instructions for use by processing unit 720, and/or a magnetic, optical, or flash memory recording and storage medium. The memory devices of memory 730 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 730 for execution by processing unit 720.

Input device 740 may include one or more mechanisms that permit an operator to input information into device 700, such as, for example, a keypad or a keyboard, a display with a touch sensitive panel, voice recognition and/or biometric mechanisms, etc. Output device 750 may include one or more mechanisms that output information to the operator, including a display, a speaker, etc. Input device 740 and output device 750 may, in some implementations, be implemented as a user interface (UI) that displays UI information and which receives user input via the UI. Communication interface 760 may include a transceiver(s) that enables device 700 to communicate with other devices and/or systems. For example, communication interface 760 may include one or more wired and/or wireless transceivers for communicating via mobile network 110 and/or a data network. In the case of RUs of gNBs/eNBs 130, communication interface 760 may further include one or more antenna arrays for producing radio frequency (RF) cells or cell sectors.

The configuration of components of network device 700 illustrated in FIG. 7 is for illustrative purposes. Other configurations may be implemented. Therefore, network device 700 may include additional, fewer and/or different components, that may be arranged in a different configuration, than depicted in FIG. 7.

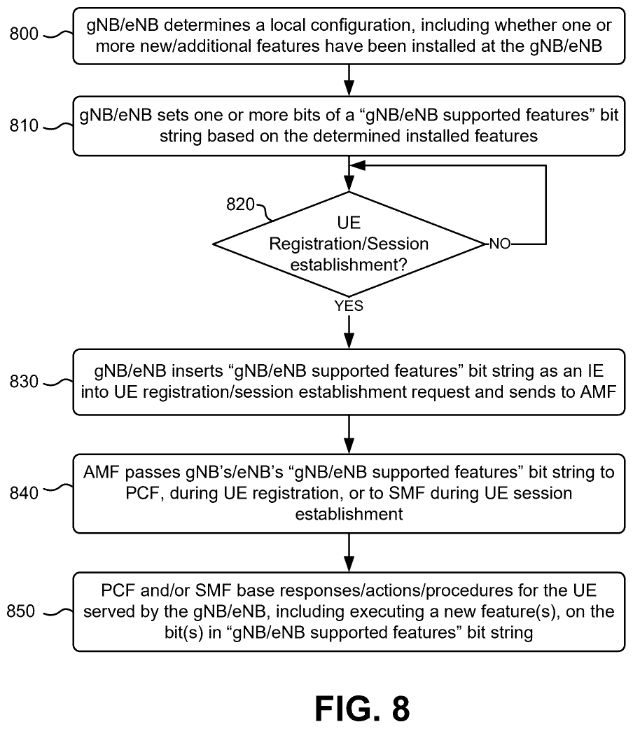

FIG. 8 is a flow diagram of an example process for a gNB/eNB 130 to notify one or more NFs of mobile network 110 of new or upgraded features, currently installed and activated at the gNB/eNB 130, for use by the NFs during UE-related procedures. The exemplary process of FIG. 8 may be implemented by a gNB/eNB 130 in conjunction with one or more NFs (e.g., AMF 145, SMF 140, PCF 160) of mobile network 110. FIG. 8 describes an example process that involves gNB/eNB 130 sending a “gNB/eNB supported features” bit string to AMF 145, and on to either SMF 140 or PCF 160. In further implementations, gNB/eNB 130 may send the “gNB/eNB supported features” bit string to other NFs, other than AMF 145, SMF 140, or PCF 160, in mobile network 110 which may then implement new or upgraded features based on the bit values in the bit string.

The exemplary process includes gNB/eNB 130 determining a local configuration, including whether one or more new or upgraded features have been installed at the gNB/eNB 130 (block 800) and are currently activated (e.g., turned on), and setting one or more bits of the “gNB/eNB supported features” bit string 500 based on the determined installed features (block 810). The new or upgraded features may include new or upgraded software or hardware features installed, and activated (i.e., turned on), at the gNB/eNB 130. The new or upgraded features may include, for example, the UE-AMBR feature, “Voice over NR Service” feature, UE-slice-AMBR support feature, and/or “high throughput” support feature described above. Blocks 800 and 810 may be performed upon each occurrence of power-up or re-start of the gNB/eNB 130, or upon the installation and activation of each new/upgraded feature at the gNB/eNB 130.

When a UE registration request or a UE session establishment request is received from a UE 105 served by the gNB/eNB 130 (YES-block 820), then gNB/eNB 130 inserts the “gNB/eNB supported features” bit string as an IE into a UE registration request or UE session establishment request message and sends the message to the AMF 145 that serves the gNB/eNB 130 (block 830). gNB/eNB 130 may insert the “gNB/eNB supported features” bit string into other types of messages, other than UE registration requests or UE session establishment requests, that are sent to one or more NFs or other nodes in mobile network 110. Block 820 may repeat (NO-block 820) until a UE registration request or a UE session establishment request is received from a UE 105 served by the gNB/eNB 130.

The AMF 145 passes the gNB/eNB 130's “gNB/eNB supported features” bit string to the PCF 160 during UE registration, or to the SMF 140 during UE session establishment (block 840), and the PCF 160 and/or SMF 140 then bases responses, actions, or procedures for the UE 105 served by the gNB/eNB 130, including executing one or more new/upgraded features, on the bit(s) in the received “gNB/eNB supported features” bit string (block 850). During UE registration involving the PCF 160, the PCF 160 may derive policies for the UE 105 served by the gNB/eNB 130 based on the bit values in the “gNB/eNB supported features” bit string and further based on a subscriber profile associated with the UE 105. During UE session establishment involving the SMF 140, the SMF 140 may execute a different session management procedure for the UE 105 served by the gNB/eNB 130 based on the bit values in the “gNB/eNB supported features” bit string. Executing the one or more new/upgraded features for the UE 105 may include executing the UE-AMBR feature, the “Voice over NR Service” feature, the UE-slice-AMBR support feature, and/or the “high throughput” support feature, described above, based on the bit values in the “gNB/eNB supported features” bit string and possibly based on other factors, such as, for example, a subscriber profile associated with the UE 105. Executing the one or more new/upgraded features for the UE 105 may include executing one or more other operator-specific features not described herein. Thus, the operator of mobile network 110 may design their own new/upgraded NF and a “gNB/eNB supported feature” bit may be created in bit string 500 that identifies whether the new/upgraded NF has been installed and activated at a gNB/eNB 130.

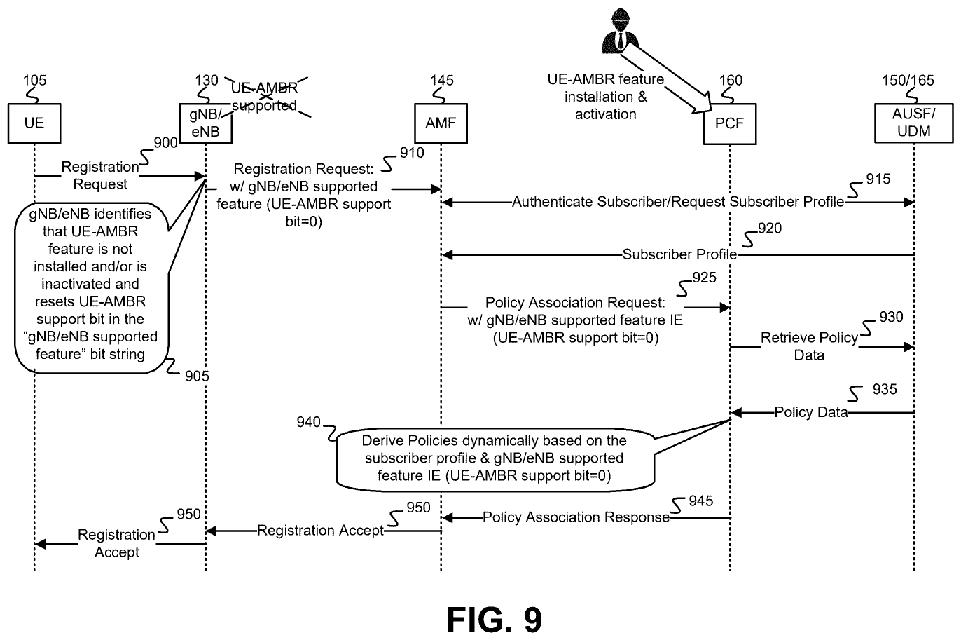

FIG. 9 illustrates an example messaging diagram associated with a UE 105 registering with the mobile network 110 in circumstances where a new UE-AMBR feature has been installed in at least one NF in the core network 125, but has not yet been installed and activated at the gNB/eNB 130 serving the UE 105. As previously described, the UE-AMBR feature controls a maximum aggregate data rate allowed for a UE 105 on the DL and/or UL to/from a gNB/eNB 130.

As shown, UE 105 begins a registration process with mobile network 110 by sending a Registration request 900 to gNB/eNB 130. gNB/eNB 130, in response to receipt of the request 900, identifies, among other possible new/upgraded features within gNB/eNB 130's local configuration, that the UE-AMBR feature is currently not installed and/or is inactivated at gNB/eNB 130 and resets the UE-AMBR support bit (i.e., UE-AMBR support bit=0) in the “gNB/eNB supported feature” bit string 500. gNB/eNB 130 than inserts the “gNB/eNB supported feature” bit string 500 as an IE into the Registration Request 910, where the UE-AMBR support bit of the bit string 500 indicates that gNB/eNB 130 does not support the UE-AMBR feature or the UE-AMBR feature is currently inactivated at gNB/eNB 130. gNB/eNB 130 forwards the Registration Request 910 to the AMF 145 which serves gNB/eNB 130. Upon receipt of the Registration Request 910, AMF 145 engages in authentication 915 with AUSF 150 and requests the subscriber profile, of the subscriber associated with UE 105, from UDM 165. UDM 165, in response, returns the subscriber profile 920 to AMF 145. The subscriber profile may include, among other data, data that identifies a type of the subscriber and the subscriber's price plan.

AMF 145 then inserts the “gNB/eNB supported feature” bit string 500 as an IE into a Policy Association Request 925 for the UE 105, where the UE-AMBR support bit of the bit string 500 indicates that gNB/eNB 130 does not support the UE-AMBR feature, or the UE-AMBR feature is currently inactivated at gNB/eNB 130, and sends the Request 925 to PCF 160. PCF 160, upon receipt of the Request 925, retrieves 930 policy data 935 from UDM 165, and then derives 940 policies for UE 105 dynamically based on the previously received subscriber profile and the “gNB/eNB supported feature” bit string, including the UE-AMBR support bit being equal to zero. The policies for UE 105 may include at least one policy rule or condition that relates to various aspects of providing mobile network service to the UE 105, including, for example, Quality of Service (QOS), traffic steering, network slicing, and access control.

In the example of FIG. 9, the policies for UE 105 include the UE-AMBR parameter value(s) which controls a maximum aggregate data rate allowed for the UE 105. The UE-AMBR parameter represents a QoS parameter that manages and allocates network resources among different UEs 105. The UE-AMBR parameter may include a single data rate value, in bits per second (bps), that applies to both the UL from the UE 105 to the gNB/eNB 130, and the DL from the gNB/eNB 130 to the UE 105, or the UE-AMBR parameter may include two distinct, and possibly different, data rate values: an AMBR for uplink (AMBR-UL) value and an AMBR for downlink (AMBR-DL) value. The AMBR-UL value specifies the maximum data rate for uplink traffic from the UE 105 to RAN 120 of mobile network 110. The AMBR-UL value, thus, sets an upper limit on a UE 105's ability to upload data to the mobile network 110, and may be specified in bps. The AMBR-DL value specifies the maximum data rate for downlink traffic from the RAN 120 of mobile network 110 to the UE 105. Likewise, the AMBR-DL value sets an upper limit on a UE 105's ability to download data from the mobile network 110, and may also be specified in bps. The combination of AMBR-UL and AMBR-DL defines a total aggregate maximum bit rate for the UE 105 that may be used to alter the distribution of mobile network resources (e.g., RAN resources) by the gNB/eNB 130 among multiple UEs 105 for both UL and DL transmissions.

PCF 160 returns a Policy Association Response 945 to AMF 145, containing the policy(ies)/condition(s) to be applied to traffic associated with UE 105. Since the UE-AMBR support bit in the “gNB/eNB supported feature” bit string was reset to zero, indicating that gNB/eNB 130 does not support the UE-AMBR feature, the Policy Association Response 945 does not contain any UE-AMBR parameter value(s). AMF 145, upon receipt of the Policy Association Response 945, sends a Registration Accept 950 to gNB/eNB 130, which forwards the Registration Accept 950 to UE 105, completing the UE registration process. DL and UL RAN resources at gNB/eNB 130 are allocated to UE 105 using existing methods, without altering the distribution of RAN resources among the UE 105 and other UEs 105 as would be implemented if the Policy Association Response 945 included a UE-AMBR parameter value(s).

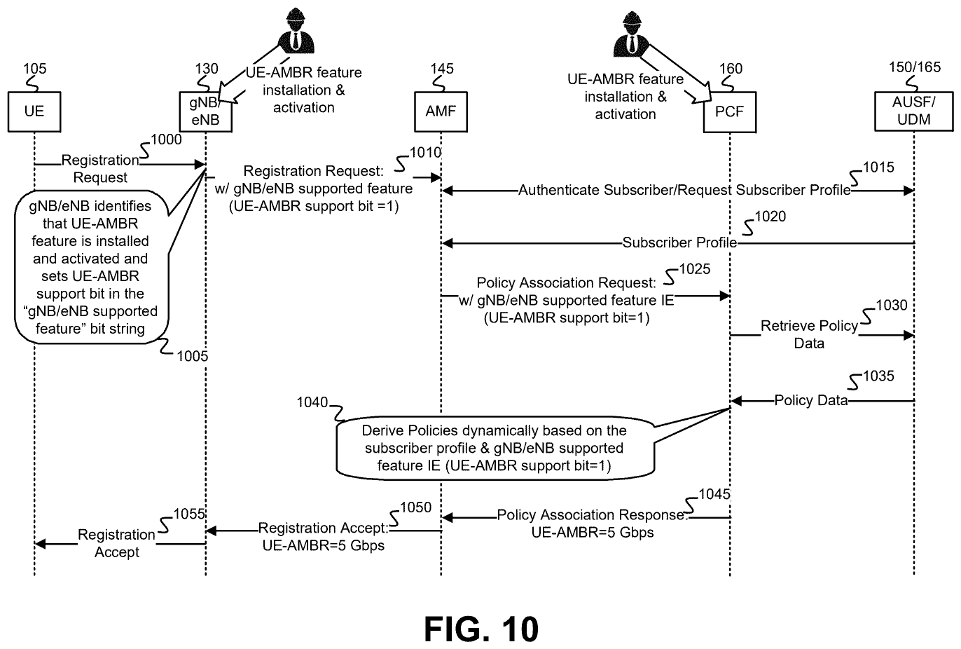

FIG. 10 illustrates an example messaging diagram associated with a UE 105 registering with the mobile network 110 in circumstances where a new UE Aggregate Maximum Bit Rate (UE-AMBR) feature has been installed in at least one NF in the core network 125 (e.g., PCF 160), and has also been installed and activated at the gNB/eNB 130 serving the UE 105.

As shown, UE 105 begins a registration process with mobile network 110 by sending a Registration Request 1000 to gNB/eNB 130. gNB/eNB 130, in response to receipt of the request 1000, identifies, among other possible new/upgraded features within gNB/eNB 130's local configuration, that the UE-AMBR feature is currently installed and activated at gNB/eNB 130 and sets the UE-AMBR support bit (i.e., UE-AMBR support bit=1) in the “gNB/eNB supported feature” bit string 500. gNB/eNB 130 than inserts the “gNB/eNB supported feature” bit string 500 as an IE into the Registration Request 1010, where the UE-AMBR support bit of the bit string 500 indicates that gNB/eNB 130 supports the UE-AMBR feature and that the UE-AMBR feature is currently activated at gNB/eNB 130. gNB/eNB 130 forwards the Registration Request 1010 to the AMF 145 which serves gNB/eNB 130. Upon receipt of the Registration Request 1010, AMF 145 engages in authentication 1015 with AUSF 150 and requests the subscriber profile, of the subscriber associated with UE 105, from UDM 165. UDM 165, in response, returns the subscriber profile 1020 to AMF 145. As previously described, the subscriber profile may include, among other data, data that identifies a type of the subscriber and the subscriber's price plan.

AMF 145 then inserts the “gNB/eNB supported feature” bit string 500 as an IE into a Policy Association Request 1025 for the UE 105, where the UE-AMBR support bit of the bit string 500 indicates that gNB/eNB 130 supports the UE-AMBR feature and the UE-AMBR feature is currently activated at gNB/eNB 130, and sends the Request 1025 to PCF 160. PCF 160, upon receipt of the Request 1025, retrieves 1030 policy data 1035 from UDM 165, and then derives 1040 a policy(ies) for UE 105 dynamically based on the previously received subscriber profile and the “gNB/eNB supported feature” bit string, including the UE-AMBR support bit being equal to one. The policy for UE 105 may include at least one policy rule or condition that relates to various aspects of providing mobile network service to the UE 105, including, for example, Quality of Service (QOS), traffic steering, network slicing, and access control.

In the example of FIG. 10, the policy/condition derived for UE 105 includes the UE-AMBR parameter value(s). As described previously, the UE-AMBR parameter may include a single data rate value that applies to both the UL from the UE 105, and the DL to the UE 105, or the UE-AMBR parameter may include two distinct, and possibly different, data rate values: the AMBR-UL value and the AMBR-DL value (not shown in FIG. 10). PCF 160 returns a Policy Association Response 1045 to AMF 145, containing the policy(ies)/condition(s) to be applied to traffic associated with UE 105. Since the UE-AMBR support bit in the “gNB/eNB supported feature” bit string was set to one, indicating that gNB/eNB 130 supports the UE-AMBR feature and that the UE-AMBR feature is currently activated at gNB/eNB 130, the Policy Association Response 1045 contains a UE-AMBR parameter value(s) that specifies the maximum UL and DL data rate to/from gNB/eNB 130 for the UE 105. In the example of FIG. 10, PCF 160 derives a policy/condition, based on the UE 105's subscriber profile and the UE-AMBR being set to one, that specifies an aggregate maximum bit rate of 5 Gigabps (Gbps) (e.g., UE-AMBR=5 Gbps). AMF 145, upon receipt of the Policy Association Response 1045, sends a Registration Accept 1050 to gNB/eNB 130, which, in turn, sends a corresponding Registration Accept 1055 to UE 105, completing the UE registration process. The Registration Accept 1050 from AMF 145 to gNB/eNB 130 includes the UE-AMBR parameter value (e.g., UE-AMBR=5 Gbps) that gNB/eNB 130 can then use to alter the distribution of DL and UL RAN resources to UE 105, and to other UEs 105 served by gNB/eNB 130. In the example of FIG. 10, gNB/eNB 130 allocates 5 Gbps of available bandwidth at gNB/eNB 130 to UE 105 for UL and DL transmissions from/to UE 105.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIG. 8, and sequences of operations, messages, and/or data flows with respect to FIGS. 6A, 6B, 9, and 10, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 720) of a device. A non-transitory storage medium includes one or more of the storage mediums described in relation to memory 730. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a base station in a mobile network, a message from a User Equipment device (UE) that is related to providing mobile network service to the UE;
identifying a local software and/or hardware configuration of the base station, including identifying installation of a set of possible new or upgraded features of the base station;
generating a data identifier that identifies each installed and active one of the set of possible new or upgraded features of the base station;
inserting the data identifier into an information element (IE) of the message; and
sending, by the base station, the message to a node of the mobile network.

2. The method of claim 1, wherein the node of the mobile network comprises an Access and Mobility Management Function (AMF).

3. The method of claim 1, wherein the message comprises one of a UE registration request or a UE session establishment request.

4. The method of claim 3, wherein the UE registration request or the UE session establishment request are sent to the node of the mobile network for delivery to a Policy Control Function (PCF) of the mobile network for a policy control response or action or for delivery to a Session Management Function (SMF) of the mobile network for management of a session involving the UE.

5. The method of claim 1, wherein the data identifier comprises a bit string, with each bit of the bit string corresponding to a respective one of the set of possible new or upgraded features, and wherein generating the data identifier further comprises:
setting each bit of the bit string corresponding to each possible new or updated feature that has been installed and is currently active at the base station.

6. The method of claim 5, wherein generating the data identifier further comprises:
resetting each bit of the bit string corresponding to each possible new or updated feature that has not been installed, or has been installed but is currently not active, at the base station.

7. The method of claim 1, wherein identifying the local software and/or hardware configuration of the base station further comprises at least one of the following:
identifying installation of a UE Aggregate Maximum Bit Rate (UE-AMBR) feature at the base station;
identifying installation of a Voice over New Radio (NR) Service feature at the base station;
identifying installation of a network slicing UE Aggregate Maximum Bit Rate (UE-AMBR) feature at the base station; or
identifying installation of a high throughput feature at the base station.

8. The method of claim 1, wherein identifying the local software and/or hardware configuration of the base station further comprises:
identifying whether a first new or upgraded feature is installed and activated at the base station, and
identifying whether a second new or upgraded feature is installed and activated at the base station; and
wherein the data identifier comprises a bit string and wherein generating the data identifier further comprises:
setting or resetting a first bit of the bit string based on whether the first new or upgraded feature is installed and activated at the base station, and
setting or resetting a second bit of the bit string based on whether the second new or upgraded feature is installed and activated at the base station.

9. A base station of a mobile network, comprising:
at least one communication interface configured to communicate via the mobile network; and
at least one processor configured to:
receive, via the at least one communication interface, a message from a User Equipment device (UE) that is related to providing mobile network service to the UE;
identify a local software and/or hardware configuration of the base station, including identifying installation of a set of possible new or upgraded features of the base station;
generate a data identifier that identifies each installed and active one of the set of possible new or upgraded features of the base station;
insert the data identifier into an information element (IE) of the message; and
send, via the at least one communication interface, the message to a node of a mobile network.

10. The base station of claim 9, wherein the node of the mobile network comprises an Access and Mobility Management Function (AMF).

11. The base station of claim 9, wherein the message comprises one of a UE registration request or a UE session establishment request.

12. The base station of claim 11, wherein the UE registration request or the UE session establishment request are sent to the node of the mobile network for delivery to a Policy Control Function (PCF) of the mobile network for a policy control response or action or for delivery to a Session Management Function (SMF) of the mobile network for management of a session involving the UE.

13. The base station of claim 9, wherein the data identifier comprises a bit string, with each bit of the bit string corresponding to a respective one of the set of possible new or upgraded features, and wherein, when generating the data identifier, the processor is further configured to:
set each bit of the bit string corresponding to each possible new or updated feature that has been installed and is currently active at the base station.

14. The base station of claim 13, wherein, when generating the data identifier, the processor is further configured to:
reset each bit of the bit string corresponding to each possible new or updated feature that has not been installed, or has been installed but is currently not active, at the base station.

15. The base station of claim 9, wherein, when identifying the local software and/or hardware configuration of the base station, the processor is further configured to perform at least one of the following:
identify installation of a UE Aggregate Maximum Bit Rate (UE-AMBR) feature at the base station;
identify installation of a Voice over New Radio (NR) Service feature at the base station;
identify installation of a network slicing UE Aggregate Maximum Bit Rate (UE-AMBR) feature at the base station; or
identify installation of a high throughput feature at the base station.

16. The base station of claim 9, wherein, when identifying the local software and/or hardware configuration of the base station, the processor is further configured to:
identify whether a first new or upgraded feature is installed and activated at the base station, and
identify whether a second new or upgraded feature is installed and activated at the base station; and
wherein the data identifier comprises a bit string and wherein, when generating the data identifier, the processor is further configured to:
set or reset a first bit of the bit string based on whether the first new or upgraded feature is installed and activated at the base station, and
set or reset a second bit of the bit string based on whether the second new or upgraded feature is installed and activated at the base station.

17. A non-transitory storage medium storing instructions executable by a base station of a mobile network, wherein execution of the instructions cause the base station to:
receive a message from a User Equipment device (UE) that is related to providing mobile network service to the UE;
identify a local software and/or hardware configuration of the base station, including identifying installation of a set of possible new or upgraded features of the base station;
generate a data identifier that identifies each installed and active one of the set of possible new or upgraded features of the base station;
insert the data identifier into an information element (IE) of the message; and
send the message to a node of the mobile network.

18. The non-transitory storage medium of claim 17, wherein the data identifier comprises a bit string, with each bit of the bit string corresponding to a respective one of the set of possible new or upgraded features, and wherein, when generating the data identifier, execution of the instructions further causes the base station to:
set each bit of the bit string corresponding to each possible new or updated feature that has been installed and is currently active at the base station; and
reset each bit of the bit string corresponding to each possible new or updated feature that has not been installed, or has been installed but is currently not active, at the base station.

19. The non-transitory storage medium of claim 17, wherein the message comprises one of a UE registration request or a UE session establishment request, and wherein the UE registration request or the UE session establishment request are sent to the node of the mobile network for delivery to a Policy Control Function (PCF) of the mobile network for a policy control response or action or for delivery to a Session Management Function (SMF) of the mobile network for management of a session involving the UE.

20. The non-transitory storage medium of claim 18, wherein, when identifying the local software and/or hardware configuration of the base station, execution of the instructions further causes the base station to perform at least one of:
identify installation of a UE Aggregate Maximum Bit Rate (UE-AMBR) feature at the base station;
identify installation of a Voice over New Radio (NR) Service feature at the base station;
identify installation of a network slicing UE Aggregate Maximum Bit Rate (UE-AMBR) feature at the base station; or
identify installation of a high throughput feature at the base station.
